(19) United States
(12) Patent Application Publication
(10) Pub. No.: US 2012/0074683 A1
(43) Pub. Date: Mar. 29, 2012

(54) MEDICATION RECORATION SYSTEM AND METHOD

(76) Inventor: Jan Gehrki, Williamburg, VA (US)

(21) Appl. No.: 12/889,405

(22) Filed: Sep. 24, 2010

(51) Int. Cl. B42D 15/00

(52) U.S. Cl. 283/81

(57) ABSTRACT

A medication recordation system comprising a removable sheet pad including a plurality of single sheets stacked upon each other, where the plurality of single sheets has a sticky backing to hold the plurality of single sheets in place, a printed surface upon the plurality of single sheets, where the printed surface appears as a clock face, a base upon which to attach the removable sheet pad, and a set of marking utensils attached upon the base, next to the removable sheet pad wherein the set of marking utensils mark a time a medication is taken upon the printed surface of the single sheet.

### BACKGROUND OF THE INVENTION

1. Field of the Invention

The present invention relates to a system to record the time when one or more doses of medication are taken throughout a day. The system assists a user to remember when and if they took their medication as to ensure proper dosage.

2. Description of Related Art

Today, many people require medication on a daily basis in order to live normal or even functional lives. Medications are necessary for a plethora of reasons. Whether used for an illness, to relieve pain, enhance immunity or enable normal bodily functions, medicines are designed to serve very specific purposes. All medications come with proper dosing instructions to inform the patients how to use the medicine correctly and to prevent additional harm or pain. As such, medications should only be taken when prescribed by a doctor, in the amount prescribed and for the duration recommended.

Unfortunately, some people do not follow the doctor's properly prescribed directions. A common problem occurs when patients cannot properly manage their pills either due to severe illness, old age, recent surgery or the like. Such patients are often prone to mistakes such as missing a dosage, mix-ups or overmedicating. There are limited alternatives to assist patients when to take their medications or when medications were taken. Many times a person may take their pills and then forget whether or not they took their pills. Thus, the person may either overdose because they forgot, or miss a dose because they thought the pills were already taken.

It would be beneficial in the art to provide a system to aid a person in monitoring and tracking when their medications were taken. It would also be desirable to ensure that the system is easy to use so that all patients will benefit from using the system.

### SUMMARY OF THE INVENTION

In view of the foregoing disadvantages inherent in the prior art, the present invention provides a medication recordation system comprising a removable sheet pad including a plurality of single sheets stacked upon each other, where the plurality of single sheets has a sticky backing to hold the plurality of single sheets in place, a printed surface upon the plurality of single sheets, where the printed surface appears as a clock face, a base upon which to attach the removable sheet pad, and a set of marking utensils attached upon the base, next to the removable sheet pad wherein the set of marking utensils mark a time a medication is taken upon the printed surface of the single sheet.

An object of the present invention is to provide a system to aid a patient when managing and monitoring their medications.

Another object of the present invention is to provide a system, which is easy for patients and caretakers to use.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a medication recordation system in accordance with an exemplary embodiment of the present invention; and

FIG. 2 a perspective view of a medication bottle in accordance with an exemplary embodiment of the present invention.

### Like reference numerals refer to like parts throughout the description of several views of the drawings.

### DETAILED DESCRIPTION OF THE DRAWINGS

The present invention relates to a system to record the time when one or more doses of medication are taken throughout a day. The system assists a user to remember the timing and amount of dosage to ensure proper administration of the medication. The medication recording system comprises a round shaped pad of paper marked like a clock face with the numbers 1-12 printed around the edges. The system enables a patient to easily track the time at which their medications are taken. The patient may simply place an individual sheet of paper upon the medication bottle and mark the time when the pills are ingested. Different color markers may be used for morning and evening doses, and additional colors to indicate any additional doses required there between. Every day the individual sheets may be removed as to record the next day's times. The medication recordation system may effectively assure that patients take their medications at the appropriate time thus preventing improper dosage or usage of the vital medications.

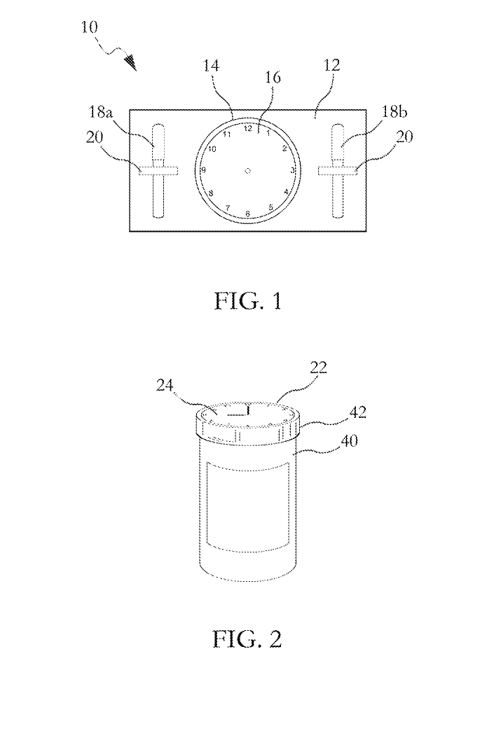

Turning now descriptively to the drawings, referring to FIG. 1, a perspective view of a medication recordation system (10) is shown in accordance with an exemplary embodiment of the present invention. The medication recordation system (10) may comprise a base (12), a removable sheet pad (14) and a set of marking utensils (18a and 18b). The base (12) may be a backing or bottom for a variety of other elements to attach. The base (12) may be made from a cardstock, a piece of plastic or a portion of thin rubber. The removable sheet pad (14) may be mounted on the base (12). The removable sheet pad (14) may be shaped as a circle or square and available in a variety of colors. The removable sheet pad (14) may include a plurality of single sheets (hereinafter single sheets) attached one on top of the other. The removable sheet pad (14) may also include a reusable material like plastic sheets. A printed surface (16) is provided on top of the single sheets. In one particular embodiment, the printed surface (16) includes display a clock face including a series of numbers from 1-12 or 1-24.

Accordingly, the set of marking utensils (18a and 18b) may be placed in close proximity to the removable sheet pad (14) as shown. The one of the marking utensils (18a and 18b) may be attached each side of the removable sheet pad (14) in distinguishing colors. A first color may be used to mark the time the first dose of medication was taken, possibly in the morning dose, and a second color may be used to mark the time the second dose of medication was taken, possibly the afternoon or evening dose. A red marker may be used for the morning dose, and a blue marker may be used for the afternoon dose. A third or even fourth color marking utensil may be used if more than one or two doses are required to be taken during the day. The set of marking utensils (18a and 18b) may be secured to the base (12) with a securing means (20). The securing means (20) may be an elastic strip, a portion of hook and loop fasteners or a sticky tab. The securing means (20) may enable a user to remove the set of marking utensils (18a and 18b) from the base (12) and then easily reattach them for storage.

Now referring to FIG. 2, a perspective view of a medication bottle (40) is shown in accordance with an exemplary embodiment of the present invention. The medication bottle (40) includes a lid (42), and atop the lid (42) a single sheet (22) from the removable sheet pad is attached. The single sheet (22) sticks to the lid (42) with a sticky portion on the back of the single sheet (22). A set of marks (24) on the printed surface of the single sheet (22) may indicate the time that medication was taken. More than one set of marks (24) may be one the printed surface, differing by color, to indicate what time the medication was in the morning and when it was taken in the afternoon.

To use the medication recordation system a user may designate a color for each prespective dosage, e.g., designating a color for the morning dosage and an alternative color for the afternoon dosage. Next the user may mark the printed surface of the single sheet when the first dose is taken, and then place the single sheet on the lid of the medication bottle. When the second dose is scheduled to be taken, the user may check the bottle to ensure that the first dose was taken, and then mark the single sheet with the time the second dose was taken. At the end of the day, or the next morning, the single sheet may be removed to enable a new sheet to be placed on the bottle for the new day. The medication recordation system aids the user to remember when and if they ingested their medications and at what times. Thus, the user may better ensure that they do not skip doses or overdose on their medications.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A medication recordation system comprising:
a removable sheet pad including a plurality of single sheets stacked upon each other, where said plurality of single sheets has a sticky backing to hold said plurality of single sheets in place;
a printed surface upon said plurality of single sheets, where said printed surface appears as a clock face;
a base upon which to attach said removable sheet pad; and
a plurality of marking utensils attached upon said base, next to said removable sheet pad wherein said marking utensils mark and correlate to a time a medication is taken upon said printed surface of said plurality of single sheets, where each marking utensil is distinguished by a particular color.

2. The medication recordation system of claim 1, wherein said set of marking utensils include a first color to indicate a first dose and a second color to indicate a second dose.

3. The medication recordation system of claim 2, wherein said set of marking utensils include a third color to indicate a third dose.

4. The medication recordation system of claim 1, wherein said marking utensils are attached to said base by a hook and loop fastener.

5. The medication recordation system of claim 1, wherein said marking utensils are attached with an elastic strip affixed to said base.

6. A method of using a medication recordation system comprising the steps of:
selecting a first color for a marking utensil to indicate a first dose and selecting a second color for marking a second dose;
marking a single sheet from a removable sheet pad with a time said first dose is taken with said first color;
attaching said marking utensil to a base where the base supports the removable sheet pad;
placing said single sheet upon a lid of a medication bottle; and
marking said single sheet with said second color when a time said second dose is taken.

7. The method of using the medication recordation system of claim 5 further comprising the step of marking said single sheet with a third color to indicate a time for a third dose of medication.

8. The method of using the medication recordation system of claim 5 further comprising the step of removing said single sheet daily.
